(19) United States
(12) Patent Application Publication
(10) Pub. No.: US 2026/0313269 A1
(43) Pub. Date: Oct. 8, 2026

(54) IMAGING DEVICE

(71) Applicant: Sharp Semiconductor Innovation Corporation, Tenri City (JP)

(72) Inventors: Manabu YAMAMOTO, Tenri City (JP); Tomonari KENZAKI, Tenri City (JP); Norikazu MURAKI, Tenri City (JP)

(21) Appl. No.: 19/539,353

(22) Filed: Feb. 13, 2026

(30) Foreign Application Priority Data
Apr. 8, 2025 (JP) 2025-063886

(51) Int. Cl. H04N 25/78; H04N 25/59; H04N 25/771; H04N 25/778

(52) U.S. Cl. CPC H04N 25/78; H04N 25/59; H04N 25/771; H04N 25/778

(57) ABSTRACT

An imaging device comprises a control unit causing a transfer circuit to transfer first electric charges, generated by a photoelectric conversion unit in a first light-exposure time period, to a first electric-charge holding unit, to transfer second electric charges, generated by the photoelectric conversion unit in a second light-exposure time period shorter than the first light-exposure time period, to a second electric-charge holding unit, and to transfer the first electric charges to a floating diffusion and then to transfer the second electric charges to the floating diffusion and causing an analog-to-digital converting circuit to perform analog-to-digital conversion on a decrease selected from a first decrease in a signal voltage observed when the first electric charges and the second electric charges are transferred to the floating diffusion and a second decrease in the signal voltage observed when the second electric charges are transferred to the floating diffusion.

### CROSS-REFERENCE TO RELATED APPLICATION

The present application claims priority from Japanese Application JP2025-063886, the content of which is hereby incorporated by reference into this application.

### BACKGROUND

### 1. Field

The present disclosure relates to an imaging device.

### Background Art

Japanese Patent Application Publication No. 2007-124400 discloses a solid-state imaging device. In the solid-state imaging device, a photo diode performs photoelectric conversion to accumulate signal electric charges in a long light-exposure time period. The signal electric charges in a long light-exposure time period are read out and subjected to 10-bit AD conversion. Furthermore, the photodiode performs photoelectric conversion to accumulate signal electric charges in a short light-exposure time period. The signal electric charges in a short light-exposure time period are read out and subjected to 10-bit AD conversion. Hence, the solid-state imaging device can expand the dynamic range; however, the AD conversion is performed twice in one horizontal scanning period (see paragraphs [0005], [0006], [0012], and [0021] to [0024]).

### SUMMARY

The solid-state imaging device disclosed in Japanese Patent Application Publication No. 2007-124400 performs the AD conversion twice in one horizontal scanning period. Hence, digital signals cannot be read out quickly.

An aspect of the present disclosure is devised in view of the above problem. An aspect of the present disclosure sets out to provide, for example, an imaging device having a wide dynamic range and capable of quickly reading out digital pixel signals.

An imaging device includes: a pixel circuit including a photoelectric conversion unit, a first electric-charge holding unit, a second electric-charge holding unit, a floating diffusion, a transfer circuit that transfers electric charges from the photoelectric conversion unit to the floating diffusion either through the first electric-charge holding unit or through the second electric-charge holding unit, and an output circuit that outputs an analog pixel signal having a signal voltage based on an amount of the electric charges transferred to the floating diffusion; an analog-to-digital converting circuit configured to perform analog-to-digital conversion on a decrease in the signal voltage; and a control unit. The control unit: causes the transfer circuit to transfer first electric charges, generated by the photoelectric conversion unit in a first light-exposure time period, from the photoelectric conversion unit to the first electric-charge holding unit, to transfer second electric charges, generated by the photoelectric conversion unit in a second light-exposure time period shorter than the first light-exposure time period, from the photoelectric conversion unit to the second electric-charge holding unit, and to transfer the first electric charges from the first electric-charge holding unit to the floating diffusion and then to transfer the second electric charges from the second electric-charge holding unit to the floating diffusion; and causes the analog-to-digital converting circuit to perform analog-to-digital conversion on a decrease selected from a first decrease in the signal voltage observed when the first electric charges and the second electric charges are transferred to the floating diffusion and a second decrease in the signal voltage observed when the second electric charges are transferred to the floating diffusion.

### BRIEF DESCRIPTION OF THE DRAWINGS

FIG. 1 is a block diagram of an imaging device according to a first embodiment;

FIG. 2 is a circuit diagram of a pixel circuit, a vertical signal line, a ramp voltage generating circuit, a saturation determination voltage generating circuit, and an analog-to-digital converting circuit, all of which are included in the imaging device according to the first embodiment;

FIG. 3 is a timing diagram showing temporal variations in levels of a start trigger signal, a discharge signal, and a transfer signal in the imaging device according to the first embodiment;

FIG. 4 is a timing diagram showing temporal variations in: levels of a reset signal, transfer signals, an initial autozero signal, a saturation determination autozero signal, a saturation determination signal, an autozero signal, and a determination signal; and a signal voltage, a ramp voltage, and a saturation determination voltage in the imaging device according to the first embodiment;

FIG. 5 is a timing diagram showing temporal variations in a signal voltage, a ramp voltage, a first saturation determination voltage, and a second saturation determination voltage in the imaging device according to the first embodiment;

FIG. 6 is a timing diagram showing temporal variations in a signal voltage, a ramp voltage, and a saturation determination voltage in the imaging device according to the first embodiment;

FIG. 7 is a circuit diagram of a pixel circuit, a vertical signal line, an analog-to-digital converting circuit, and a determination circuit, all of which are included in the imaging device according to a first modification of the first embodiment;

FIG. 8 is a timing diagram showing temporal variations in a signal voltage and a saturation determination voltage in the imaging device according the first modification of the first embodiment;

FIG. 9 illustrates a block diagram of effective pixels, first optical black pixels, second optical black pixels, vertical signal lines for effective pixels, vertical signal lines for first optical black pixels, vertical signal lines for second optical black pixels, analog-to-digital converting circuits for effective pixels, analog-to-digital converting circuits for first optical black pixels, analog-to-digital converting circuits for second optical black pixels, and a correction circuit, all of which are included in the imaging device according to the first embodiment;

FIG. 10 is a graph showing a relationship between: a light-exposure time period for which a pixel included in an imaging device of a reference example performs light exposure; and an output obtained from the pixel;

FIG. 11 is a graph showing a relationship between: a light-exposure time period in which a pixel included in the imaging device of the first embodiment performs light exposure; and an output obtained from the pixel;

FIG. 12 is a graph showing a relationship between: an amount of light received with a pixel included in the imaging device of the reference example; and an output obtained from the pixel;

FIG. 13 is a graph showing a relationship between: an amount of light received with a pixel included in the imaging device of the first embodiment; and an output obtained from the pixel;

FIG. 14 is a table showing a relationship between: a count value obtained with a counter, which is included in the imaging device of the first embodiment, when a pixel circuit included in the imaging device is not saturated; and a digital value calculated with the counter; and

FIG. 15 is a table showing a relationship between: a count value obtained with the counter, which is included in the imaging device of the first embodiment, when a pixel circuit included in the imaging device is saturated; and a digital value calculated with the counter.

### DESCRIPTION OF EMBODIMENTS

Embodiments of the present disclosure will be described below, with reference to the drawings. Note that, throughout the drawings, like reference signs denote identical or similar constituent features. Such features will not be repeatedly elaborated upon.

### 1 First Embodiment

### 1.1 Imaging Device

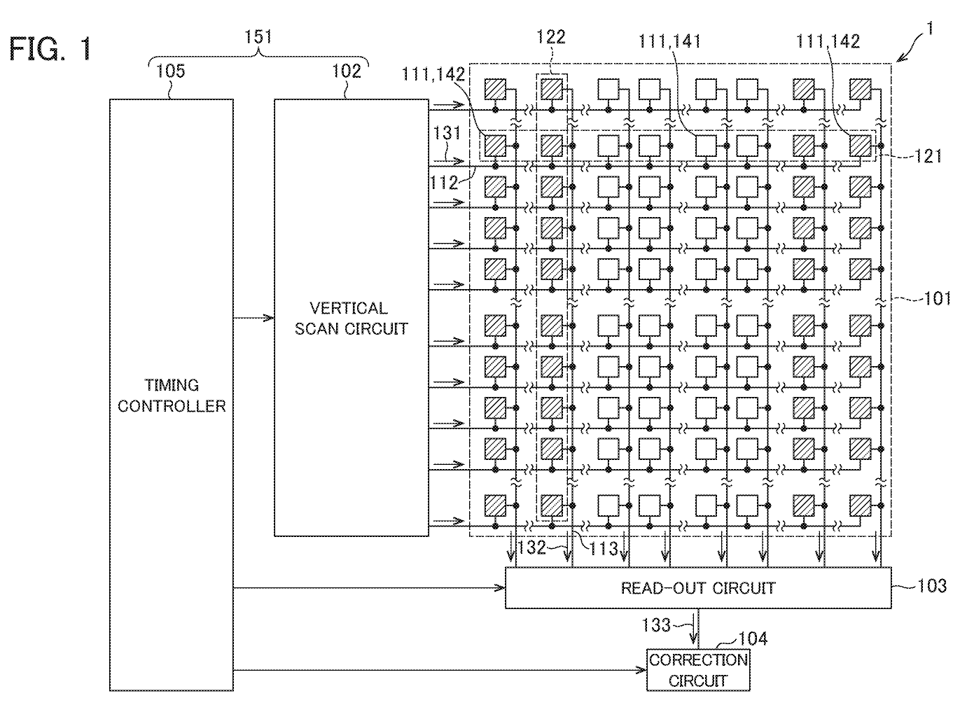

FIG. 1 is a block diagram illustrating an imaging device 1 of a first embodiment.

The imaging device 1 of the first embodiment illustrated in FIG. 1 obtains an image and outputs an image signal based on the obtained image. The imaging device 1 is a complementary metal-oxide semiconductor (CMOS) image sensor. The imaging device 1 is a global-shutter imaging device. The imaging device 1 has a single-shot HDR function capable of obtaining a high dynamic range (HDR) image by one imaging operation. Techniques to be described below may be employed for imaging devices other than CMOS image sensors.

As illustrated in FIG. 1, the imaging device 1 includes: a pixel unit 101; a vertical scan circuit 102; a read-out circuit 103; a correction circuit 104; and a timing controller 105.

As illustrated in FIG. 1, the pixel unit 101 includes: p × q pixels 111; p horizontal control lines 112; and q vertical signal lines 113.

The p × q pixels 111 are arranged in a matrix. Thus, the p × q pixels 111 include p rows 121 and q columns 122. Each of the rows 121 includes q pixels 111. Each of the columns 122 includes p pixels 111. Each of the pixels 111 receives light according to a supplied control signal 131, generates electric charges based on the received light, accumulates the generated electric charges, and discharges the accumulated electric charges. Thus, each pixel 111 outputs an analog pixel signal 132 having a signal voltage based on an amount of the accumulated electric charges. The signal voltage of the analog pixel signal 132 is lower as a larger amount of the electric charges are discharged. An absolute value of a decrease in the signal voltage of the analog pixel signal 132 is larger as a larger amount of the electric charges are discharged.

As illustrated in FIG. 1, the q pixels 111 included in each row 121 include: a plurality of effective pixels 141; and a plurality of optical black pixels 142. The plurality of effective pixels 141 is arranged in a center portion of each row 121. The plurality of optical black pixels 142 is arranged in opposing end portions of each row 121.

The p horizontal control lines 112 correspond to the respective p rows 121. Each of the horizontal control lines 112 is electrically connected to: the vertical scan circuit 102; and the q pixels 111 included in one of the rows 121 to which each horizontal control line 112 corresponds. Hence, each horizontal control line 112 transmits the control signal 131, output by the vertical scan circuit 102, from the vertical scan circuit 102 to the q pixels 111. Then, the horizontal control line 112 supplies the transmitted control signal 131 to the q pixels 111. Each horizontal control line 112 includes a plurality of signal lines for transmitting a plurality of kinds of signals included in the control signal 131.

The q vertical signal lines 113 correspond to the respective q columns 122. Each of the vertical signal lines 113 is electrically connected to: the p pixels 111 included in one of the columns 122 to which each vertical signal line 113 corresponds; and the read-out circuit 103. Hence, each of the vertical signal lines 113 transmits the analog pixel signal 132, output from a pixel 111 included in the p pixels 111, from the pixel 111 to the read-out circuit 103, and supplies the transmitted analog pixel signal 132 to the read-out circuit 103. The q vertical signal lines 113 supply q analog pixel signals 132 to the read-out circuit 103.

The vertical scan circuit 102 scans the pixel unit 101 in a vertical direction. The vertical scan circuit 102 selects, from the p horizontal control lines 112, a horizontal control line 112 to be driven and causes the selected horizontal control line 112 to transmit the control signal 131. The vertical scan circuit 102 sequentially changes the horizontal control lines 112 to be selected.

The read-out circuit 103 reads out the q analog pixel signals 132 and converts the read-out q analog pixel signals 132 into q digital pixel signals 133.

The correction circuit 104 corrects the digital pixel signals 133, obtained from the effective pixels 141, to be the digital pixel signals 133 to be obtained from the optical black pixels 142.

The timing controller 105 causes the vertical scan circuit 102 and the read-out circuit 103 to perform an operation to be described below. The timing controller 105 is an electronic circuit.

The timing controller 105 and the vertical scan circuit 102 constitute a control unit 151 that performs control to provide the imaging device 1 with the single-shot HDR function.

### 1.2 Overview of Single-Shot HDR Function

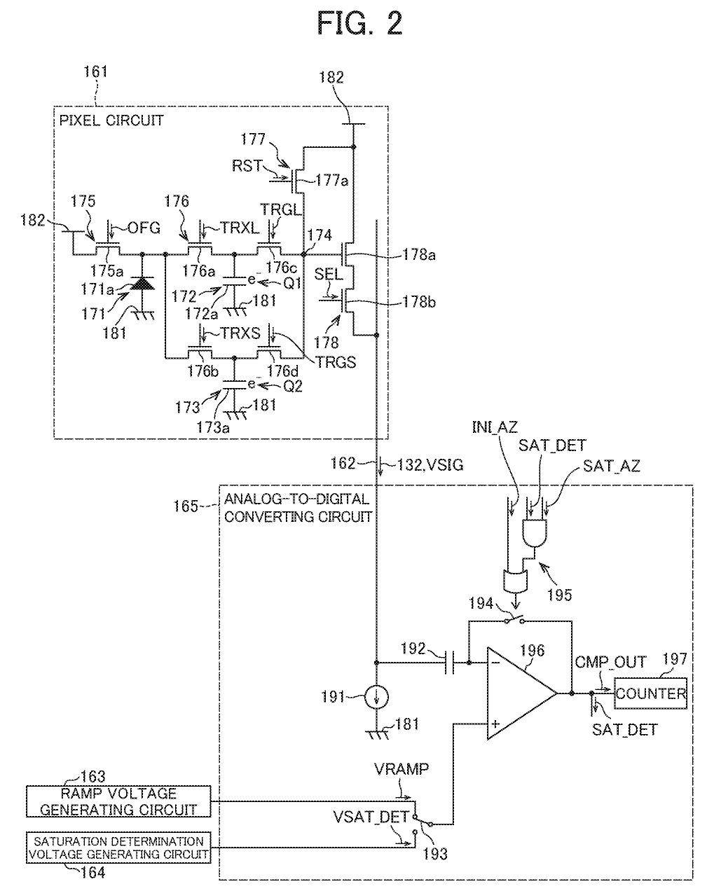

FIG. 2 is a circuit diagram of a pixel circuit 161, a vertical signal line 162, a ramp voltage generating circuit 163, a saturation determination voltage generating circuit 164, and an analog-to-digital converting circuit 165, all of which are included in the imaging device 1 according to the first embodiment.

As illustrated in FIG. 2, each pixel 111 includes a pixel circuit 161. The q vertical signal lines 113 include a vertical signal line 162 corresponding to a column 122 including each of the pixels 111. The read-out circuit 103 includes: a ramp voltage generating circuit 163; a saturation determination voltage generating circuit 164; and an analog-to-digital converting circuit 165 corresponding to the column 122 including each of the pixels 111.

In accordance with a supplied control signal 131, the pixel circuit 161 performs light exposure for a long time period to generate first electric charges Q1, and after that, performs light exposure for a short time period to generate second electric charges Q2. Then, the pixel circuit 161 accumulates the generated first electric charges Q1 and second electric charges Q2 and outputs an analog pixel signal 132 having a signal voltage VSIG based on an amount of the accumulated electric charges.

The vertical signal line 162 transmits the output analog pixel signal 132 to the analog-to-digital converting circuit 165.

The ramp voltage generating circuit 163 generates a ramp voltage VRAMP.

The saturation determination voltage generating circuit 164 generates a saturation determination voltage VSAT_DET.

The analog-to-digital converting circuit 165 performs analog-to-digital conversion on a decrease in the signal voltage VSIG, using the signal voltage VSIG of the transmitted analog pixel signal 132 and the generated ramp voltage VRAMP. The analog-to-digital converting circuit 165 is autozeroed and initialized. The decrease subjected to the analog-to-digital conversion is a decrease after the analog-to-digital converting circuit 165 is initialized. When timings at which the analog-to-digital converting circuit 165 is initialized are changed, the decrease subjected to the analog-to-digital conversion is switched between: a first decrease observed when the pixel circuit 161 accumulates the first electric charges Q1 and the second electric charges Q2; and a second decrease observed when the pixel circuit 161 accumulates the second electric charges Q2.

Using the signal voltage VSIG of the transmitted analog pixel signal 132 and the generated saturation determination voltage VSAT_DET, the analog-to-digital converting circuit 165 determines whether a third decrease in the signal voltage VSIG, which is observed when the pixel circuit 161 accumulates the first electric charges Q1, is greater than, or equal to, a reference. Then, the analog-to-digital converting circuit 165 outputs the saturation determination signal SAT_DET indicating a result of the determination. It the third decrease is not greater than, or equal to, the reference, it means that the pixel circuit 161 is not saturated. It the third decrease is greater than, or equal to, the reference, it means that the pixel circuit 161 is saturated. A level of the saturation determination signal SAT_DET to be output is a Low(L) level if the third decrease is determined not to be greater than, or equal to, the reference. A level of the saturation determination signal SAT_DET to be output is a High(H) level if the third decrease is determined to be greater than, or equal to, the reference.

The timing controller 105 causes the analog-to-digital converting circuit 165 to make the above determination.

If the analog-to-digital converting circuit 165 determines that the third decrease is not greater than, or equal to, the reference, the timing controller 105 causes the analog-to-digital converting circuit 165 to perform analog-to-digital conversion on the first decrease in the signal voltage VSIG observed when the pixel circuit 161 accumulates the first electric charges Q1 and the second electric charges Q2. If the analog-to-digital converting circuit 165 determines that the third decrease is greater than, or equal to, the reference, the timing controller 105 causes the analog-to-digital converting circuit 165 to perform analog-to-digital conversion on the second decrease in the signal voltage VSIG observed when the pixel circuit 161 accumulates the second electric charges Q2. Hence, if the pixel circuit 161 is not saturated when the pixel circuit 161 accumulates the first electric charges Q1 and the second electric charges Q2, the analog-to-digital conversion is performed on the first decrease caused by combined electric charges of the first electric charges Q1 generated by light exposure for a long time period and the second electric charges Q2 generated by light exposure for a short time period. If the pixel circuit 161 is saturated when the pixel circuit 161 accumulates the first electric charges Q1 and the second electric charges Q2, the analog-to-digital conversion is performed on the second decrease caused by the second electric charges Q2 generated by light exposure for a short time period. In this way, a decrease selected from the first decrease and the second decrease is subjected to the analog-to-digital conversion. Such a feature successfully expands the dynamic range of the imaging device 1. Furthermore, the feature successfully reduces an increase in counts of analog-to-digital conversion so that the digital pixel signal 133 can be quickly read out from the imaging device 1.

### 1.3 Pixel Circuit

As illustrated in FIG. 2, the pixel circuit 161 includes: a photoelectric conversion unit 171; a first electric-charge holding unit 172; a second electric-charge holding unit 173; a floating diffusion 174; a discharge circuit 175; a transfer circuit 176; a reset circuit 177; and an output circuit 178. The control signal 131 includes: a discharge signal OFG; a transfer signal TRXL; a transfer signal TRXS; a transfer signal TRGL; a transfer signal TRGS; a reset signal RST; and a row select signal SEL.

The photoelectric conversion unit 171 receives light, generates electric charges based on the received light, and accumulates the generated electric charges. The electric charges are accumulated in a larger amount as the light is received in a larger amount for a longer time period.

The photoelectric conversion unit 171 includes a photodiode 171a. The photodiode 171a has an anode electrically connected to a ground 181.

The first electric-charge holding unit 172 holds electric charges.

The first electric-charge holding unit 172 includes a first capacitor 172a. The first capacitor 172a has one terminal electrically connected to the ground 181.

The second electric-charge holding unit 173 holds electric charges.

The second electric-charge holding unit 173 includes a second capacitor 173a. The second capacitor 173a has one terminal electrically connected to the ground 181.

The first electric-charge holding unit 172 and the second electric-charge holding unit 173 hold electric charges independently from each other.

The floating diffusion 174 holds electric charges.

The discharge circuit 175 discharges the electric charges accumulated in the photoelectric conversion unit 171 to a power supply 182 in accordance with the supplied discharge signal OFG, and resets the photoelectric conversion unit 171.

The discharge circuit 175 includes a discharge transistor 175a. The discharge transistor 175a has a gate supplied with the discharge signal OFG. The discharge transistor 175a has a source electrically connected to a cathode of the photodiode 171a. The discharge transistor 175a has a drain electrically connected to the power supply 182. While a level of the discharge signal OFG is an L-level, the discharge transistor 175a ceases conduction between the source and the drain of the discharge transistor 175a so that the photodiode 171a does not discharge the electric charges to the power supply 182. While the level of the discharge signal OFG is an H-level, the discharge transistor 175a allows conduction between the source and the drain of the discharge transistor 175a so that the photodiode 171a discharges the electric charges to the power supply 182.

In accordance with the supplied transfer signals TRXL, TRXS, TRGL, and TRGS, the transfer circuit 176 transfers the electric charges accumulated in the photoelectric conversion unit 171 from the photoelectric conversion unit 171 to the floating diffusion 174 either through the first electric-charge holding unit 172 or through the second electric-charge holding unit 173.

The transfer circuit 176 includes: a transfer transistor 176a; a transfer transistor 176b; a transfer transistor 176c; and a transfer transistor 176d.

The transfer transistor 176a has a gate supplied with the transfer signal TRXL. The transfer transistor 176a has a source electrically connected to the cathode of the photodiode 171a. The transfer transistor 176a has a drain electrically connected to an other terminal of the first capacitor 172a. While a level of the transfer signal TRXL is an L-level, the transfer transistor 176a ceases conduction between the source and the drain of the transfer transistor 176a so that the electric charges accumulated in the photodiode 171a are not transferred to the first capacitor 172a. While the level of the transfer signal TRXL is an H-level, the transfer transistor 176a allows conduction between the source and the drain of the transfer transistor 176a so that the electric charges accumulated in the photodiode 171a are transferred to the first capacitor 172a.

The transfer transistor 176b has a gate supplied with the transfer signal TRXS. The transfer transistor 176b has a source electrically connected to the cathode of the photodiode 171a. The transfer transistor 176b has a drain electrically connected to an other terminal of the second capacitor 173a. While a level of the transfer signal TRXS is an L-level, the transfer transistor 176b ceases conduction between the source and the drain of the transfer transistor 176b so that the electric charges accumulated in the photodiode 171a are not transferred to the second capacitor 173a. While the level of the transfer signal TRXS is an H-level, the transfer transistor 176b allows conduction between the source and the drain of the transfer transistor 176b so that the electric charges accumulated in the photodiode 171a are transferred to the second capacitor 173a.

The transfer transistor 176c has a gate supplied with the transfer signal TRGL. The transfer transistor 176c has a source electrically connected to the other terminal of the first capacitor 172a. The transfer transistor 176c has a drain electrically connected to the floating diffusion 174. While a level of the transfer signal TRGL is an L-level, the transfer transistor 176c ceases conduction between the source and the drain of the transfer transistor 176c so that the electric charges accumulated in the first capacitor 172a are not transferred to the floating diffusion 174. While the level of the transfer signal TRGL is an H-level, the transfer transistor 176c allows conduction between the source and the drain of the transfer transistor 176c so that the electric charges accumulated in the first capacitor 172a are transferred to the floating diffusion 174.

The transfer transistor 176d has a gate supplied with the transfer signal TRGS. The transfer transistor 176d has a source electrically connected to the other terminal of the second capacitor 173a. The transfer transistor 176d has a drain electrically connected to the floating diffusion 174. While a level of the transfer signal TRGS is an L-level, the transfer transistor 176d ceases conduction between the source and the drain of the transfer transistor 176d so that the electric charges accumulated in the second capacitor 173a are not transferred to the floating diffusion 174. While the level of the transfer signal TRGS is an H-level, the transfer transistor 176d allows conduction between the source and the drain of the transfer transistor 176d so that the electric charges accumulated in the second capacitor 173a are transferred to the floating diffusion 174.

In accordance with the supplied reset signal RST, the reset circuit 177 discharges the electric charges, accumulated in the floating diffusion 174, to the power supply 182 and resets the floating diffusion 174.

The reset circuit 177 includes a reset transistor 177a.

The reset transistor 177a has a gate supplied with the reset signal RST. The reset transistor 177a has a source electrically connected to the floating diffusion 174. The reset transistor 177a has a drain electrically connected to the power supply 182. While a level of the reset signal RST is an L-level, the reset transistor 177a ceases conduction between the source and the drain of the reset transistor 177a so that the electric charges accumulated in the floating diffusion 174 are not transferred to the power supply 182. While the level of the reset signal RST is an H-level, the reset transistor 177a allows conduction between the source and the drain of the reset transistor 177a so that the electric charges accumulated in the floating diffusion 174 are transferred to the power supply 182.

In accordance with the supplied row select signal SEL, the output circuit 178 outputs the analog pixel signal 132 to the vertical signal line 162. Here, the analog pixel signal 132 has the signal voltage VSIG based on the amount of the electric charges transferred to, and accumulated in, the floating diffusion 174.

The output circuit 178 includes: a source follower transistor 178a; and a row select transistor 178b.

The source follower transistor 178a has a gate electrically connected to the floating diffusion 174. The source follower transistor 178a has a drain electrically connected to the power supply 182. The source follower transistor 178a has a source electrically connected to a drain of the row select transistor 178b. The source follower transistor 178a forms a source follower circuit and outputs the analog pixel signal 132 from the source of the source follower transistor 178a. Here, the analog pixel signal 132 has the signal voltage VSIG that follows a voltage of the gate of the source follower transistor 178a; that is, a voltage of the floating diffusion 174.

The row select transistor 178b has a gate supplied with the row select signal SEL. The row select transistor 178b has a drain electrically connected to the source of the source follower transistor 178a. The row select transistor 178b has a source electrically connected to the vertical signal line 162. While a level of the row select signal SEL is an L-level, the row select transistor 178b ceases conduction between the drain and the source of the row select transistor 178b so that the analog pixel signal 132, which is output from the source of the source follower transistor 178a, is not output to the vertical signal line 162. While the level of the row select signal SEL is an H-level, the row select transistor 178b allows conduction between the drain and the source of the row select transistor 178b so that the analog pixel signal 132, which is output from the source of the source follower transistor 178a, is output to the vertical signal line 162.

### 1.4 Analog-To-Digital Converting Circuit

As illustrated in FIG. 2, the analog-to-digital converting circuit 165 includes: a constant current circuit 191; a capacitor 192; a switch 193; an autozero switch 194; a processing circuit 195; a comparator 196; and a counter 197.

The constant current circuit 191 has one terminal electrically connected to the vertical signal line 162. The constant current circuit 191 has an other terminal electrically connected to the ground 181. The constant current circuit 191 passes a constant current from the one terminal to the other terminal of the constant current circuit 191. Hence, the constant current circuit 191 passes the constant current to the vertical signal line 162. Thus, when conduction is provided between the drain and the source of the row select transistor 178b so that the constant current circuit 191 is electrically connected to the source of the source follower transistor 178a through the vertical signal line 162 and the row select transistor 178b, the source follower transistor 178a and the constant current circuit 191 constitute the source follower circuit.

The capacitor 192 has one terminal electrically connected to the vertical signal line 162. The capacitor 192 has an other terminal electrically connected to an inverting input terminal of the comparator 196. The capacitor 192 generates a voltage, based on the accumulated electric charges, between the one terminal and the other terminal of the capacitor 192. Thus, the capacitor 192 lowers a voltage to be applied to the inverting input terminal of the comparator 196 by the same decrease as the decrease in the signal voltage VSIG.

The switch 193 has a first input terminal electrically connected to the ramp voltage generating circuit 163. The first input terminal of the switch 193 receives the ramp voltage VRAMP. The switch 193 has a second input terminal electrically connected to the saturation determination voltage generating circuit 164. The second input terminal of the switch 193 receives the saturation determination voltage VSAT_DET. The switch 193 has an output terminal electrically connected to a non-inverting input terminal of the comparator 196. The switch 193 switches a voltage to be output from the output terminal of the switch 193 between the input ramp voltage VRAMP and saturation determination voltage VSAT_DET. Thus, the switch 193 switches a voltage to be applied to the non-inverting input terminal of the comparator 196 between the ramp voltage VRAMP and the saturation determination voltage VSAT_DET.

The autozero switch 194 has one terminal electrically connected to the inverting input terminal of the comparator 196. The autozero switch 194 has an other terminal electrically connected to an output terminal of the comparator 196. In accordance with a supplied autozero signal AZ, the autozero switch 194 switches a state of the one terminal and the other terminal of the autozero switch 194 between a short-circuit state in which the one terminal and the other terminal are short-circuited and a non-short-circuit state in which the one terminal and the other terminal are not short-circuited. While a level of the autozero signal AZ is an L-level, the autozero switch 194 sets the state to the non-short-circuit state so that the inverting input terminal and the output terminal are not short-circuited. While the level of the autozero signal AZ is an H-level, the autozero switch 194 sets the state to the short-circuit state so that the inverting input terminal and the output terminal are short-circuited. If the inverting input terminal and the output terminal are short-circuited, the voltage of the inverting input terminal is shifted from the voltage of the non-inverting input terminal by an offset voltage of an input of the comparator 196. Even after the inverting input terminal and the output terminal are not short-circuited, the state is maintained. Hence, when the inverting input terminal and the output terminal change from the short-circuit state to the non-short-circuit state, the analog-to-digital converting circuit 165 is successfully initialized. After the analog-to-digital converting circuit 165 is initialized, the comparator 196 compares the voltage of the non-inverting input terminal observed when the analog-to-digital converting circuit 165 is initialized with a decrease in the signal voltage VSIG observed after the analog-to-digital converting circuit 165 is initialized.

The processing circuit 195 processes a supplied initial autozero signal INT_AZ, a supplied saturation determination autozero signal SAT_AZ, and the supplied saturation determination signal SAT_DET, and supplies the autozero signal AZ to the autozero switch 194. While a level of the initial autozero signal INT_AZ is an L-level and a level or levels of one or both of the saturation determination autozero signal SAT_AZ and the saturation determination signal SAT_DET are L-levels, the processing circuit 195 sets the autozero signal AZ to an L-level. While the level of the initial autozero signal INT_AZ is an H-level, the processing circuit 195 sets the autozero signal AZ to an H-level regardless of the levels of the saturation determination autozero signal SAT_AZ and the saturation determination signal SAT_DET. While the levels of both the saturation determination autozero signal SAT_AZ and the saturation determination signal SAT_DET are H-levels, the processing circuit 195 sets the autozero signal AZ to an H-level regardless of the level of the initial autozero signal INT_AZ. Hence, if the level of the initial autozero signal INT_AZ is set to the H-level, the processing circuit 195 initializes the analog-to-digital converting circuit 165 regardless of whether the pixel circuit 161 is saturated. If the level of the saturation determination autozero signal SAT_AZ is set to the H-level, the processing circuit 195 initializes the analog-to-digital converting circuit 165 when the pixel circuit 161 is saturated. When the pixel circuit 161 is not saturated, the processing circuit 195 does not initialize the analog-to-digital converting circuit 165.

The comparator 196 compares the voltage applied to the inverting input terminal of the comparator 196 with the voltage applied to the non-inverting input terminal of the comparator 196, and sets a level of the voltage output from the output terminal of the comparator 196 to an L-level if the voltage applied to the inverting input terminal is higher than the voltage applied to the non-inverting input terminal. The comparator 196 compares the voltage applied to the inverting input terminal with the voltage applied to the non-inverting input terminal, and sets the level of the voltage output from the output terminal to an H-level if the voltage applied to the inverting input terminal is lower than the voltage applied to the non-inverting input terminal. Hence, while the saturation determination voltage VSAT_DET is applied to the non-inverting input terminal, the comparator 196 sets the level of the voltage output from the output terminal to the L-level if the voltage applied to the inverting input terminal is higher than the saturation determination voltage VSAT_DET. If the voltage applied to the inverting input terminal is lower than the saturation determination voltage VSAT_DET, the comparator 196 sets the level of the voltage output from the output terminal to the H-level. While the ramp voltage VRAMP is applied to the non-inverting input terminal, the comparator 196 sets the level of the voltage output from the output terminal to the L-level if the voltage applied to the inverting input terminal is higher than the ramp voltage VRAMP. If the voltage applied to the inverting input terminal is lower than the ramp voltage VRAMP, the comparator 196 sets the level of the voltage output from the output terminal to the H-level.

Thus, while the saturation determination voltage VSAT_DET is applied to the non-inverting input terminal of the comparator 196, the capacitor 192 and the comparator 196 serve as a determination circuit that determines whether the third decrease in the signal voltage VSIG, observed when the first electric charges Q1 are transferred to the floating diffusion 174, is greater than, or equal to, a reference, and outputs the saturation determination signal SAT_DET; that is, a determination circuit that determines whether the pixel circuit 161 is saturated, and outputs the saturation determination signal SAT_DET. While the ramp voltage VRAMP is applied to the non-inverting input terminal, the capacitor 192 and the comparator 196 detect whether the first decrease or the second decrease is inverted from the ramp voltage VRAMP and output a determination signal CMPOUT. Here, the first decrease is observed of the signal voltage VSIG when the first electric charges Q1 and the second electric charges Q2 are transferred to the floating diffusion 174, and the second decrease is observed of the signal voltage VSIG when the second electric charges Q2 are transferred to the floating diffusion 174.

The counter 197 counts the number of clocks input until a timing at which a level of the determination signal CMPOUT changes from an L-level to an H-level, calculates a digital value from the count value indicating the counted number of clocks, and outputs the digital pixel signal 133 indicating the calculated digital value.

### 1.5 Light Exposure and Transfer to Electric-Charge Holding Unit

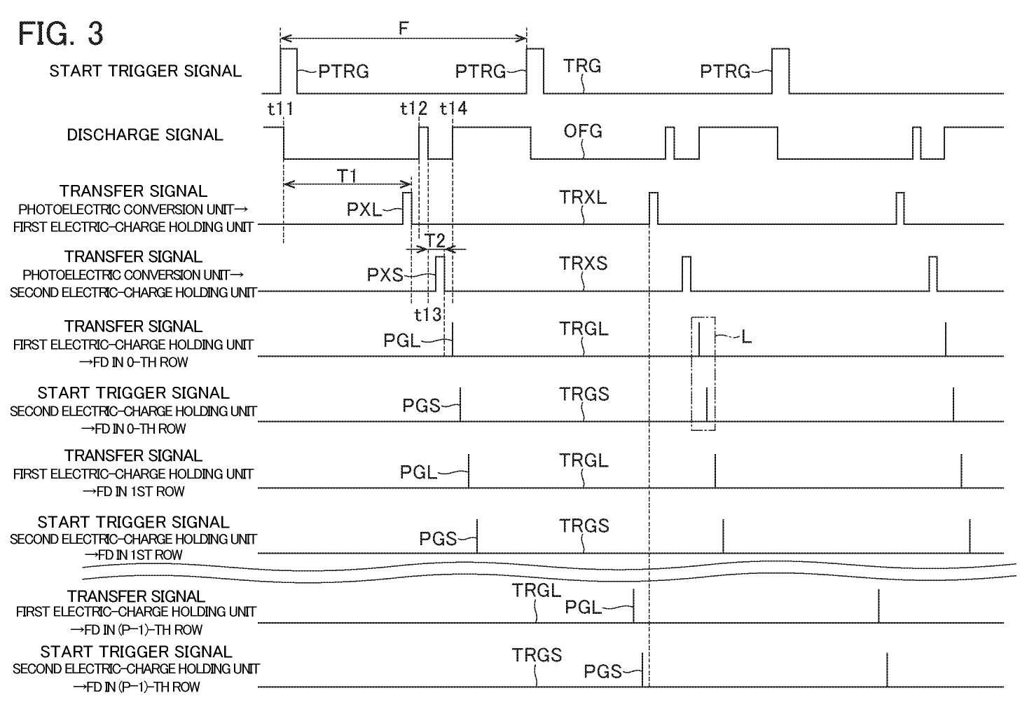

FIG. 3 is a timing diagram showing temporal variations in levels of a start trigger signal TGR, the discharge signal OFG, and the transfer signals TRXL, TRXS, TRGL, and TRGS in the imaging device 1 according to the first embodiment.

In the timing diagram of FIG. 3, the horizontal axis represents time period, and the vertical axis represents level.

As shown in FIG. 3, the start trigger signal TRG includes a plurality of start trigger pulses PTRG. A timing at which each of the start trigger pulses PTRG rises is a start timing of one frame period F. A timing at which a succeeding start trigger pulse PTRG rises, following each start trigger pulse PTRG, is an end timing of the one frame period F. Each pulse interval between the plurality of start trigger pulses PTRG corresponds to one frame period. For example, if a frame rate of imaging is 60 fps, the pulse interval corresponds to 16.66 ms; that is, one frame period.

The timing controller 105 causes the vertical scan circuit 102 to supply a common discharge signal OFG to the p × q pixels 111. The timing controller 105 causes the vertical scan circuit 102 to: change the level of the discharge signal OFG from the H-level to the L-level at a timing t11 during each frame period F; change the level of the discharge signal OFG from the L-level to the H-level at a timing t12 during each frame period F; change the level of the discharge signal OFG from the H-level to the L-level at a timing t13 during each frame period F, and change the level of the discharge signal OFG from the L-level to the H-level at a timing t14 during each frame period F. Hence, in a period from the start timing of each frame period F to the timing t11, the electric charges generated by the photoelectric conversion unit 171 are discharged to the power supply 182. In a period from the timing t11 to the timing t12, the electric charges generated by the photoelectric conversion unit 171 are not discharged to the power supply 182. In a period from the timing t12 to the timing t13, the electric charges generated by the photoelectric conversion unit 171 are discharged to the power supply 182. In a period from the timing t13 to the timing t14, the electric charges generated by the photoelectric conversion unit 171 are not discharged to the power supply 182. In a period from the timing t14 to the end timing of each frame period F. the electric charges generated by the photoelectric conversion unit 171 are discharged to the power supply 182. The period from the timing t11 to the timing t12 is longer than a first light-exposure time period T1 during which the light exposure is performed for a long time period. The period from the timing t13 to the timing t14 is longer than a second light-exposure time period T2 during which the light exposure is performed for a short time period.

The timing controller 105 causes the vertical scan circuit 102 to supply the common transfer signal TRXL and the common transfer signal TRXS to the p × q pixels 111.

The transfer signal TRXL includes a transfer pulse PXL. The timing controller 105 causes the vertical scan circuit 102 to generate the transfer pulse PXL during a period from the timing t11 to the timing t12. A length of the period from the timing t11 to a timing at which the transfer pulse PXL falls is the first light-exposure time period T1 during which the light exposure is performed for a long time period. Hence, the control unit 151 causes the transfer circuit 176 to transfer the first electric charges Q1, to be generated by the photoelectric conversion unit 171 in the first light-exposure time period T1, from the photoelectric conversion unit 171 to the first electric-charge holding unit 172.

The transfer signal TRXS includes a transfer pulse PXS. The timing controller 105 causes the vertical scan circuit 102 to generate the transfer pulse PXS during a period from the timing t13 to the timing t14. A length of the period from the timing t13 to a timing at which the transfer pulse PXS falls is the second light-exposure time period T2 during which the light exposure is performed for a short time period. Hence, the control unit 151 causes the transfer circuit 176 to transfer the second electric charges Q2, to be generated by the photoelectric conversion unit 171 in the second light-exposure time period T2, from the photoelectric conversion unit 171 to the second electric-charge holding unit 173.

The second light-exposure time period T2 is shorter than the first light-exposure time period T1. FIG. 3 shows temporal variations in levels of the discharge signal OFG, the transfer signal TRXL, and the transfer signal TRXS in a case where a ratio of the first light-exposure time period T1 to the second light-exposure time period T2 is 7:1 and a ratio of a sum T1 + T2 of the first light-exposure time period T1 and the second light-exposure time period T2 to the second light-exposure time period T2 (hereinafter referred to as an “HDR ratio”) is 8:1. The HDR ratio may vary from 8:1.

The timing controller 105 causes the vertical scan circuit 102 to supply transfer signals TRGL different from one another and transfer signals TRGS different from one another to a 0-th row 121, a first row 121, ..., a (p − 1)-th row 121. The timing controller 105 causes the vertical scan circuit 102 to supply a common transfer signal TRGL and a common transfer signal TRGS to the q pixels 111 included in each row 121.

The transfer signal TRGL includes a transfer pulse PGL. The timing controller 105 causes the vertical scan circuit 102 to generate the transfer pulse PGL during a period from a timing at which the transfer pulse PXS falls and a timing at which the transfer pulse PXL rises. Hence, the control unit 151 causes the transfer circuit 176 to transfer the first electric charges Q1, held in the first electric-charge holding unit 172, to the floating diffusion 174.

The transfer signal TRGS includes a transfer pulse PGS. The timing controller 105 causes the vertical scan circuit 102 to generate the transfer pulse PGS during a period from a timing at which the transfer pulse PXS falls and a timing at which the transfer pulse PXL rises. Hence, the control unit 151 causes the transfer circuit 176 to transfer the second electric charges Q2, held in the second electric-charge holding unit 173, to the floating diffusion 174. The timing controller 105 causes the vertical scan circuit 102 to generate the transfer pulse PGL and, after that, the transfer pulse PXS. Hence, the control unit 151 causes the transfer circuit 176 to transfer the first electric charges Q1 to the floating diffusion 174 and, after that, the second electric charges Q2 to the floating diffusion 174.

### 1.6 Transfer and Analog-to-Digital Conversion

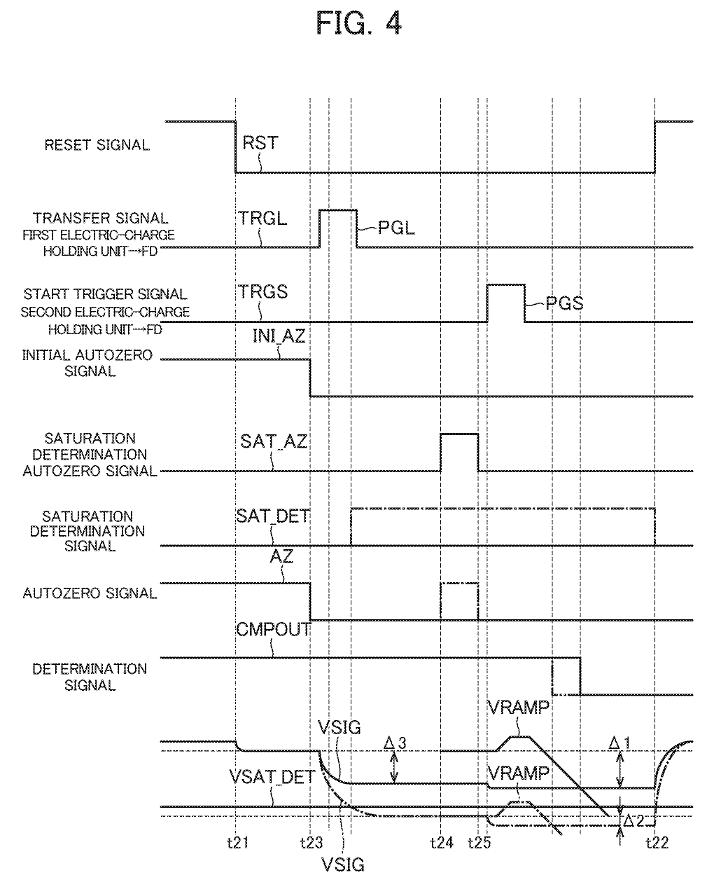

FIG. 4 is a timing diagram showing temporal variations in: levels of the reset signal RST, the transfer signal TRGL, the transfer signal TRGS, the initial autozero signal INT_AZ, the saturation determination autozero signal SAT_AZ, the saturation determination signal SAT_DET, the autozero signal AZ, and the determination signal CMPOUT; and the signal voltage VSIG, the ramp voltage VRAMP, and the saturation determination voltage VSAT_DET in the imaging device 1 according to the first embodiment.

In the timing diagram of FIG. 4, the horizontal axis represents time period, and the vertical axis represents voltage. In the timing diagram of FIG. 4, solid lines represent temporal variations in: levels of the saturation determination signal SAT_DET, the autozero signal AZ, and the determination signal CMPOUT; and the signal voltage VSIG and the ramp voltage VRAMP, when the pixel circuit 161 is not saturated. Dash-dotted lines represent temporal variations in: levels of the saturation determination signal SAT_DET, the autozero signal AZ, and the determination signal CMPOUT; and the signal voltage VSIG and the ramp voltage VRAMP, when the pixel circuit 161 is saturated. The timing diagram in FIG. 4 corresponds to a portion L of the timing diagram in FIG. 3.

As illustrated in FIG. 4, the timing controller 105 causes the vertical scan circuit 102 to supply the reset signal RST to each of the rows 121. The timing controller 105 causes the vertical scan circuit 102 to change the level of the reset signal RST from the H-level to the L-level at a timing t21 and from the L-level to the H-level at a timing t22. Hence, in a period before the timing t21, the electric charges transferred to the floating diffusion 174 are discharged to the power supply 182. In a period from the timing t21 to the timing t22, the electric charges transferred to the floating diffusion 174 are not discharged to the power source 182. In a period after the timing t22, the electric charges transferred to the floating diffusion 174 are discharged to the power supply 182. Hence, in the period from the timing t21 to the timing t22, the electric charges transferred to the floating diffusion 174 are accumulated in the floating diffusion 174.

The timing controller 105 causes the vertical scan circuit 102 to generate the transfer pulse PGL during the period from the timing t21 to the timing t22. As a result, the first electric charges Q1 held in the first electric-charge holding unit 172 are transferred to, and accumulated in, the floating diffusion 174.

The timing controller 105 causes the vertical scan circuit 102 to generate the transfer pulse PGS during the period from the timing t21 to the timing t22. As a result, the second electric charges Q2 held in the second electric-charge holding unit 173 are transferred to, and accumulated in, the floating diffusion 174.

After the reset of the floating diffusion 174 is completed, the signal voltage VSIG further decreases because the first electric charges Q1 are transferred to the floating diffusion 174, and still further decreases because the second electric charges Q2 are transferred to the floating diffusion 174.

The level of the saturation determination signal SAT_DET is the L-level in a case where the decrease in the signal voltage VSIG is not greater than, or equal to, a reference determined by the saturation determination voltage VSAT_DET and where the signal voltage VSIG is not lower than, or equal to, the saturation determination voltage VSAT_DET. The level of the saturation determination signal SAT_DET is the H-level in a case where the decrease in the signal voltage VSIG is greater than, or equal to, a reference determined by the saturation determination voltage VSAT_DET and where the signal voltage VSIG is lower than, or equal to, the saturation determination voltage VSAT_DET.

The timing controller 105 supplies the processing circuit 195 with the initial autozero signal INT_AZ. The timing controller 105 changes the level of the initial autozero signal INT_AZ from the H-level to the L-level at a timing t23 that is in a period before a timing at which the transfer pulse PGL rises.

The timing controller 105 supplies the processing circuit 195 with the saturation determination autozero signal SAT_AZ. The timing controller 105 changes the level of the saturation determination autozero signal SAT_AZ from the L-level to the H-level at a timing t24 that is in a period from a timing at which the transfer pulse PGL falls to a timing at which the transfer pulse PGS rises. At a timing t25 in the period, the timing controller 105 changes the level of the saturation determination autozero signal SAT_AZ from the H-level to the L-level.

The level of the saturation determination signal SAT_DET varies to the H-level in the period from the timing at which the transfer pulse PGL falls to the timing at which the transfer pulse PGS rises in a case where the third decrease Δ3 in the signal voltage VSIG, observed when the first electric charges Q1 are transferred to the floating diffusion 174, is determined to be greater than, or equal to, the reference. In the period, the level of the saturation determination signal SAT_DET falls to the L-level in a case where the third decrease Δ3 is determined not to be greater than, or equal to, the reference.

The processing circuit 195 supplies the autozero switch 194 with the autozero signal AZ. The level of the autozero signal AZ varies from the L-level to the H-level at the timing t23. Hence, the analog-to-digital converting circuit 165 is initialized before the first electric charges Q1 are transferred to the floating diffusion 174. Hence, the analog-to-digital converting circuit 165 successfully: detects whether the first decrease Δ1 in the signal voltage VSIG, observed when the first electric charges Q1 and the second electric charges Q2 are transferred to the floating diffusion 174, is inverted from the ramp voltage VRAMP; performs analog-to-digital conversion on the first decrease Δ1; and determines whether the third decrease Δ3 in the signal voltage VSIG, observed when the first electric charges Q1 are transferred to the floating diffusion 174, is greater than, or equal to, a reference. Furthermore, if the third decrease Δ3 is determined to be greater than, or equal to, the reference, the level of the autozero signal AZ varies: from the L-level to the H-level at the timing t24; and from the H-level to the L-level at the timing t25. Hence, if the pixel circuit 161 is saturated, the analog-to-digital converting circuit 165 is initialized again after the first electric charges Q1 are transferred to the floating diffusion 174 and before the second electric charges Q2 are transferred to the floating diffusion 174. Hence, the analog-to-digital converting circuit 165 successfully detects whether the second decrease Δ2 in the signal voltage VSIG of the analog pixel signal 132 is inverted from the ramp voltage VRAMP, and performs analog-to-digital conversion on the second decrease Δ2. Here, the second decrease Δ2 is observed when the second electric charges Q2 are transferred to the floating diffusion 174.

The ramp voltage VRAMP is matched with the signal voltage VSIG when the analog-to-digital converting circuit 165 is initialized. Then, the ramp voltage VRAMP is raised to, and maintained at, a highest voltage, and decreased from the highest voltage to a lowest voltage. Hence, if the pixel circuit 161 is not saturated, the analog-to-digital converting circuit 165 successfully performs analog-to-digital conversion on the first decrease Δ1. Furthermore, if the pixel circuit 161 is saturated, the analog-to-digital converting circuit 165 successfully performs analog-to-digital conversion on the second decrease Δ2.

The determination signal CMPOUT varies from the H-level to the L-level at a timing t26 at which the signal voltage VSIG falls below the ramp voltage VRAMP.

### 1.7 Reference of Saturation Determination Voltage

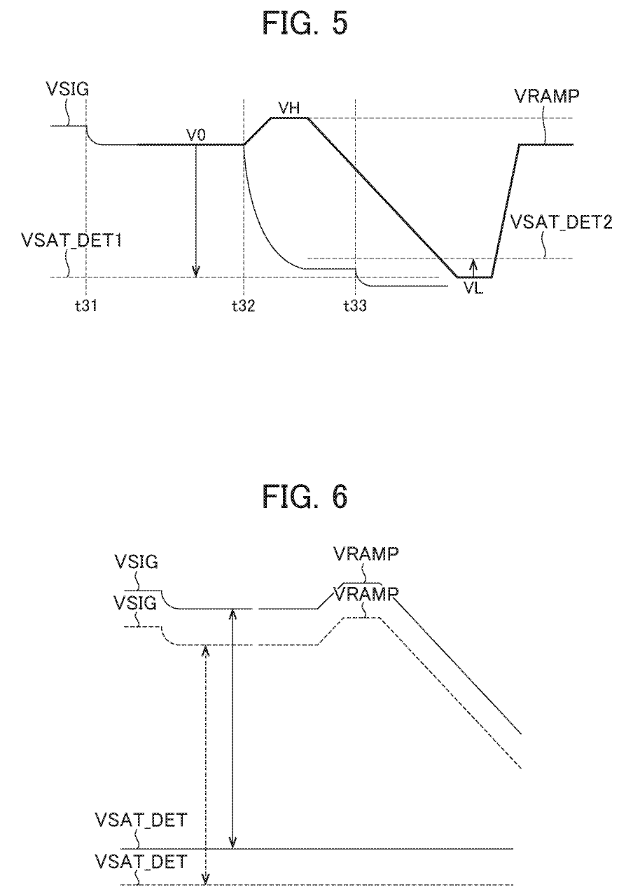

FIG. 5 is a timing diagram showing temporal variations in the signal voltage VSIG, the ramp voltage VRAMP, a first saturation determination voltage VSAT_DET1, and a second saturation determination voltage VSAT_DET2 in the imaging device 1 according to the first embodiment.

In the timing diagram of FIG. 5, the horizontal axis represents time period, and the vertical axis represents voltage.

As shown in FIG. 5, the signal voltage VSIG decreases after a timing t31 at which the reset of the floating diffusion 174 is completed, further decreases after a timing t32 at which the first electric charges Q1 are transferred to the floating diffusion 174, and still further decreases after a timing t33 at which the second electric charges Q2 are transferred to the floating diffusion 174.

The analog-to-digital converting circuit 165 is initialized during a period from the timing t31 to the timing t32.

The ramp voltage VRAMP is set to an initial voltage V0 that matches the signal voltage VSIG of the analog pixel signal 132 when the analog-to-digital converting circuit 165 is initialized. Then, the ramp voltage VRAMP is raised from the initial voltage V0 to a highest voltage VH, maintained at the highest voltage VH, and decreased from the highest voltage VH to a lowest voltage VL.

The saturation determination voltage generating circuit 164 can set the saturation determination voltage VSAT_DET either to the first saturation determination voltage VSAT_DET1 or to the second saturation determination voltage VSAT_DET2 shown in FIG. 5.

The first saturation determination voltage VSAT_DET1 is generated with reference to the initial voltage V0. The first saturation determination voltage VSAT_DET1 is lower than the first initial voltage V0 by a set voltage. The first saturation determination voltage VSAT_DET1 is a saturation determination voltage for detecting significant decrease in the signal voltage VSIG from the initial voltage V0.

The second saturation determination voltage VSAT_DET2 is generated with reference to the lowest voltage VL. The second saturation determination voltage VSAT_DET2 is higher than the lowest voltage VL by a set voltage. The second saturation determination voltage VSAT_DET2 is a saturation determination voltage for detecting significant proximity of the signal voltage VSIG to the lowest voltage VL.

FIG. 6 is a timing diagram showing temporal variations in the signal voltage VSIG, the ramp voltage VRAMP, and the saturation determination voltage VSAT_DET in the imaging device 1 according to the first embodiment.

In the timing diagram of FIG. 6, the horizontal axis represents time period, and the vertical axis represents voltage. In the timing diagram of FIG. 6, solid lines represent temporal variations in the signal voltage VSIG, the ramp voltage VRAMP, and the saturation determination voltage VSAT_DET, all of which are observed when the signal voltage VSIG is relatively high, and dashed lines represent temporal variations in the signal voltage VSIG, the ramp voltage VRAMP, and the saturation determination voltage VSAT_DET, all of which are observed when the signal voltage VSIG is relatively low.

The signal voltage VSIG fluctuates before the first electric charges Q1 are transferred to the floating diffusion 174. Hence, as shown in FIG. 6, the signal voltage VSIG would be either relatively high as represented by the solid lines or relatively low as represented by the dashed lines.

If the analog-to-digital converting circuit 165 is initialized after the signal voltage VSIG fluctuates, the saturation determination signal SAT_DET does not fluctuate even if the signal voltage VSIG fluctuates. This is because, when the analog-to-digital converting circuit 165 is initialized even if the signal voltage VSIG fluctuates, a voltage of the inverting input terminal of the comparator 196 is set to a voltage of the non-inverting input terminal of the comparator 196 observed when the analog-to-digital converting circuit 165 is initialized; that is, the initial voltage V0 of the ramp voltage VRAMP, and a fluctuation component of the signal voltage VSIG is cancelled as a voltage across the terminals of the capacitor 192.

### 1.8 Effect of Independent Determination Circuit

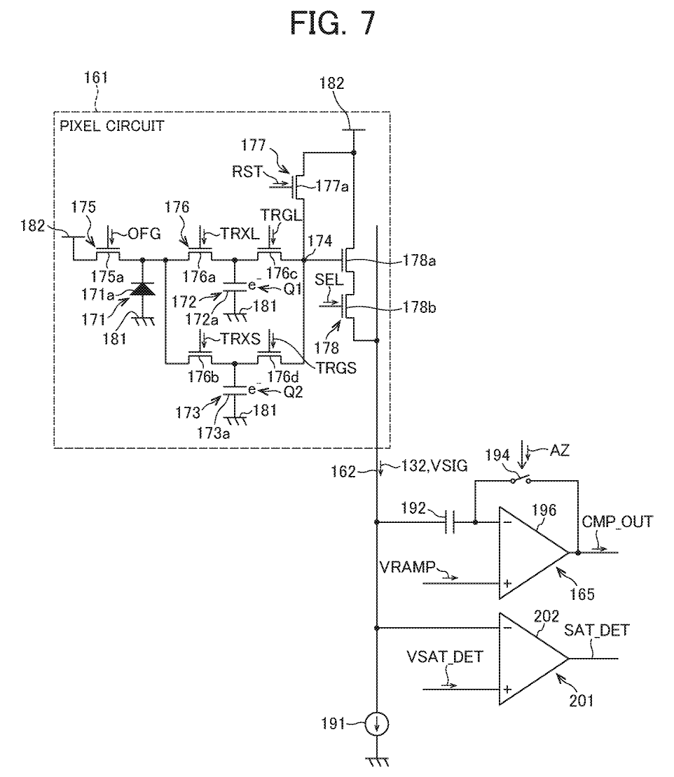

FIG. 7 is a circuit diagram of a pixel circuit 161, a vertical signal line 162, an analog-to-digital converting circuit 165, and a determination circuit 201, all of which are included in an imaging device according to a first modification of the first embodiment.

In the first modification of the first embodiment, the determination circuit 201 independent of the analog-to-digital converting circuit 165 determines whether the third decrease Δ3 is greater than, or equal to, a reference, and outputs the saturation determination signal SAT_DET.

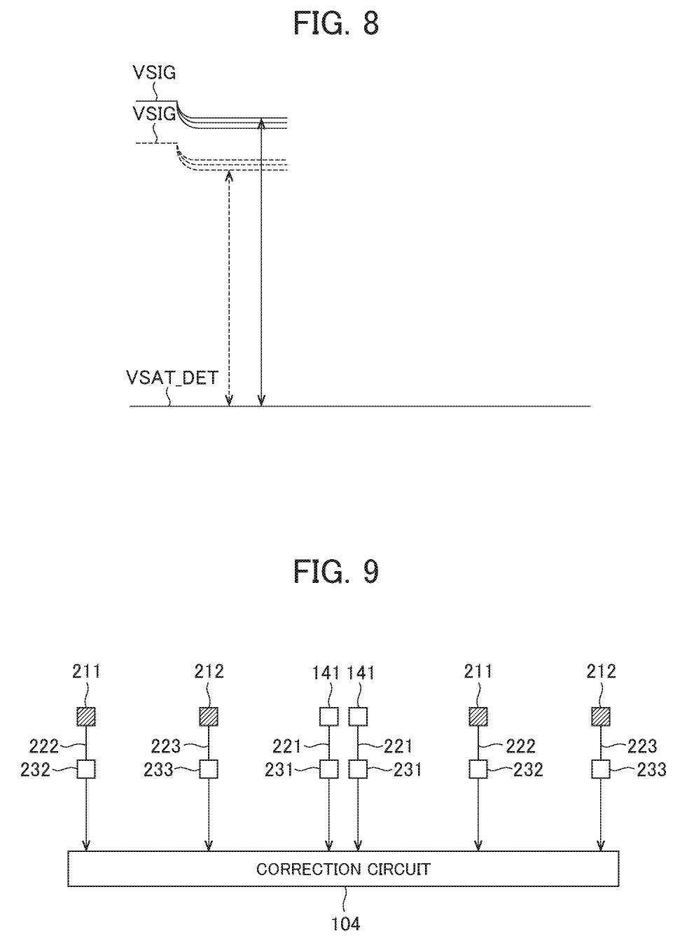

FIG. 8 is a timing diagram showing temporal variations in a signal voltage VSIG and a saturation determination voltage VSAT_DET in the imaging device according the first modification of the first embodiment.

In the timing diagram of FIG. 8, the horizontal axis represents time period, and the vertical axis represents voltage. In the timing diagram of FIG. 8, solid lines represent temporal variations in the signal voltage VSIG when the signal voltage VSIG is relatively high, and dashed lines represent temporal variations in the signal voltage VSIG when the signal voltage VSIG is relatively low.

As shown in FIG. 8, the signal voltage VSIG would be either relatively high as represented by the solid lines or relatively low as represented by the dashed lines. Fluctuations in the signal voltage VSIG are caused by fluctuations in the signal voltage VSIG before the floating diffusion 174 is reset and by fluctuations in the signal voltage VSIG after the floating diffusion 174 is reset. The fluctuations in the signal voltage VSIG before the floating diffusion 174 is reset are caused by fluctuations in characteristics of the source follower transistor 178a.

If the determination circuit 201 independent of the analog-to-digital converting circuit 165 outputs the saturation determination signal SAT_DET, even though the inverting input terminal of the comparator 196 included in analog-to-digital converting circuit 165 is directly connected to the vertical signal line 162 through the capacitor 192, the inverting input terminal of the comparator 202 included in the determination circuit 201 is directly connected to the vertical signal line 162. Hence, the signal voltage VSIG and the saturation determination voltage VSAT_DET are directly input to the comparator 202. Thus, if the signal voltage VSIG fluctuates, the saturation determination voltage VSAT_DET fluctuates.

### 1.9 Switching Optical Black Pixels to be used for Correction

FIG. 9 illustrates a block diagram of effective pixels 141, first optical black pixels 211, second optical black pixel 212, vertical signal lines 221 for the effective pixels 141, vertical signal lines 222 for the first optical black pixels 211, vertical signal lines 223 for the second optical black pixels 212, analog-to-digital converting circuits 231 for effective pixels 141, analog-to-digital converting circuits 232 for first optical black pixels 211, analog-to-digital converting circuits 233 for the second optical black pixels 212, and the correction circuit 104, all of which are included in the imaging device 1 according to the first embodiment.

As illustrated in FIG. 9, the q pixels 111 included in each row 121 include: an effective pixel 141; a first optical black pixel 211; and a second optical black pixel 212. The q vertical signal lines 113 include: a vertical signal line 221 for an effective pixel 141; a vertical signal line 222 for a first optical black pixel 211; and a vertical signal line 223 for a second optical black pixel 212. The read-out circuit 103 includes: an analog-to-digital converting circuit 231 for an effective pixel 141; an analog-to-digital converting circuit 232 for a first optical black pixel 211; and an analog-to-digital converting circuit 233 for a second optical black pixel 212. The first optical black pixels 211 are substantially equal in number to the second optical black pixels 212.

Each of the analog-to-digital converting circuit 231 for an effective pixel 141, the analog-to-digital converting circuit 232 for a first optical black pixel 211, and the analog-to-digital converting circuit 233 for a second optical black pixel 212 performs analog-to-digital conversion on a decrease in the signal voltage VSIG of the analog pixel signal 132 output from the effective pixel 141, the first optical black pixel 211, and the optical black pixel 212.

The control unit 151 causes the analog-to-digital converting circuit 232 for a first optical black pixel 211 to perform analog-to-digital conversion on the first decrease Δ1. The control unit 151 causes the analog-to-digital converting circuit 233 for a second optical black pixel 212 to perform analog-to-digital conversion on the second decrease Δ2.

If the analog-to-digital converting circuit 231 for an effective pixel 141 performs analog-to-digital conversion on the first decrease Δ1, the correction circuit 104 corrects the digital pixel signal 133 to be obtained from the effective pixel 141, using the digital pixel signal 133 to be obtained from the first optical black pixel 211. If the analog-to-digital converting circuit 231 for an effective pixel 141 performs analog-to-digital conversion on the second decrease Δ2, the correction circuit 104 corrects the digital pixel signal 133 to be obtained from the effective pixel 141, using the digital pixel signal 133 to be obtained from the second optical black pixel 212. Such features successfully match a kind of the decrease converted from analog to digital by the analog-to-digital converting circuit 231 for an effective pixel 141 with a kind of the decrease to be used for the correction. Hence, the correction can be made appropriately. A digital pixel signal 133 to be obtained from the effective pixel 141 on the left is corrected with a digital pixel signal 133 to be obtained from either the first optical black pixel 211 or the second optical black pixel 212 on the left. A digital pixel signal 133 to be obtained from the effective pixel 141 on the right is corrected with a digital pixel signal 133 to be obtained from either the first optical black pixel 211 or the second optical black pixel 212 on the right.

### 1.10 Relationship between Amount of Light and Pixel Value

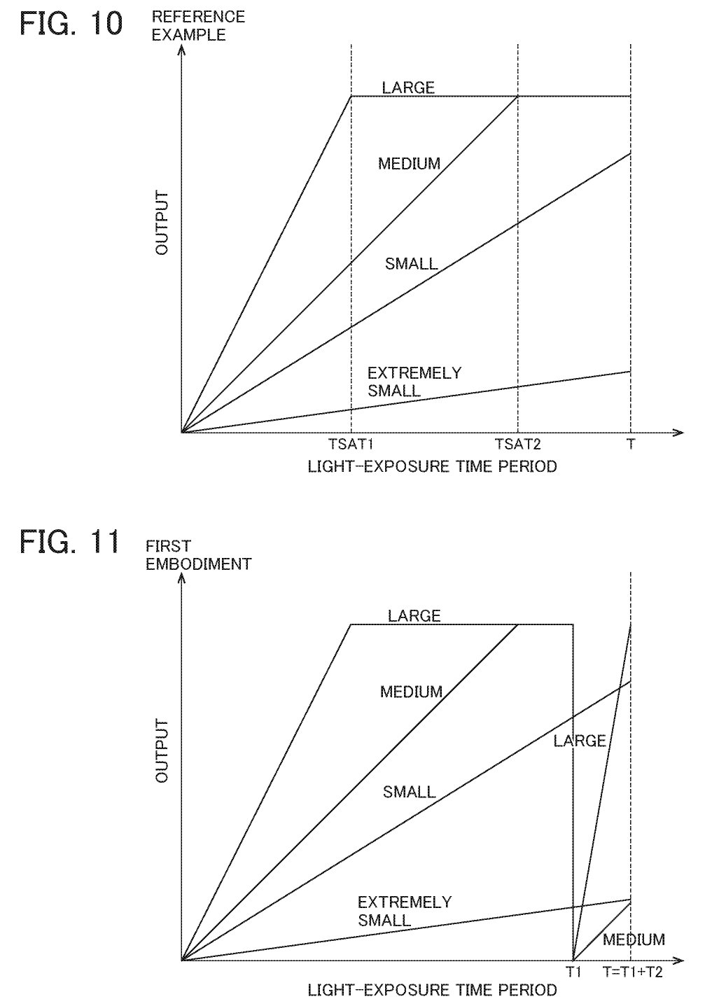

FIG. 10 is a graph showing a relationship between: a light-exposure time period for which a pixel included in an imaging device of a reference example performs light exposure; and an output obtained from the pixel. FIG. 11 is a graph showing a relationship between: a light-exposure time period for which a pixel 111 included in the imaging device 1 of the first embodiment performs light exposure; and an output obtained from the pixel 111.

In the graphs of FIGS. 10 and 11, the horizontal axis represents light-exposure time period and the vertical axis represents output. The graphs of FIGS. 10 and 11 show a relationship between the light-exposure time period and the output when an amount of light received with the pixel is extremely small, small, medium, and large.

As to the imaging device of the reference example, if the amount of light is extremely small or small, the pixel circuit 161 is not saturated until the light-exposure time period reaches a time period T. Whereas, if the amount of light is medium or large, the pixel circuit 161 is saturated before the light-exposure time period reaches the time period T. Hence, as shown in FIG. 10, if the amount of light is extremely small or small, the output is greater as the light-exposure time period is longer until the light-exposure time period reaches the time period T. However, if the amount of light is medium or large, the output is larger as the light-exposure time period is longer before the light-exposure time period reaches either a saturation time period TSAT1 or a saturation time period STAT2 both shorter than the time period T; however, after the exposure time period reaches either the saturation time period TSAT1 or the saturation time period STAT2, the output does not change even if the light-exposure time period is longer.

As to the imaging device 1 of the first embodiment, if the amount of light is extremely small or small, the pixel circuit 161 is not saturated until the light-exposure time period reaches the time period T. Hence, if the amount of light is extremely small or small, the analog-to-digital converting circuit 165 is initialized before the first electric charges Q1 are transferred to the floating diffusion 174; however, the analog-to-digital converting circuit 165 is not initialized after the first electric charges Q1 are transferred to the floating diffusion 174. Whereas, if the amount of light is medium or large, the pixel circuit 161 is saturated before the light-exposure time period reaches the time period T. Hence, the analog-to-digital converting circuit 165 is initialized before the first electric charges Q1 are transferred to the floating diffusion 174, and after the first electric charges Q1 are transferred to the floating diffusion 174, the analog-to-digital converting circuit 165 is initialized again. Hence, as shown in FIG. 11, if the amount of light is extremely small or small, the output is greater as the light-exposure time period is longer until the light-exposure time period reaches the first light-exposure time period T1. However, if the amount of light is medium or large, the output is larger as the light-exposure time period is longer before the light-exposure time period reaches the first light-exposure time period T1. When the light-exposure time period reaches the first light-exposure time period T1, the output returns to 0. After the light-exposure time period reaches the first light-exposure time period T1, the output is greater as the light-exposure time period is longer.

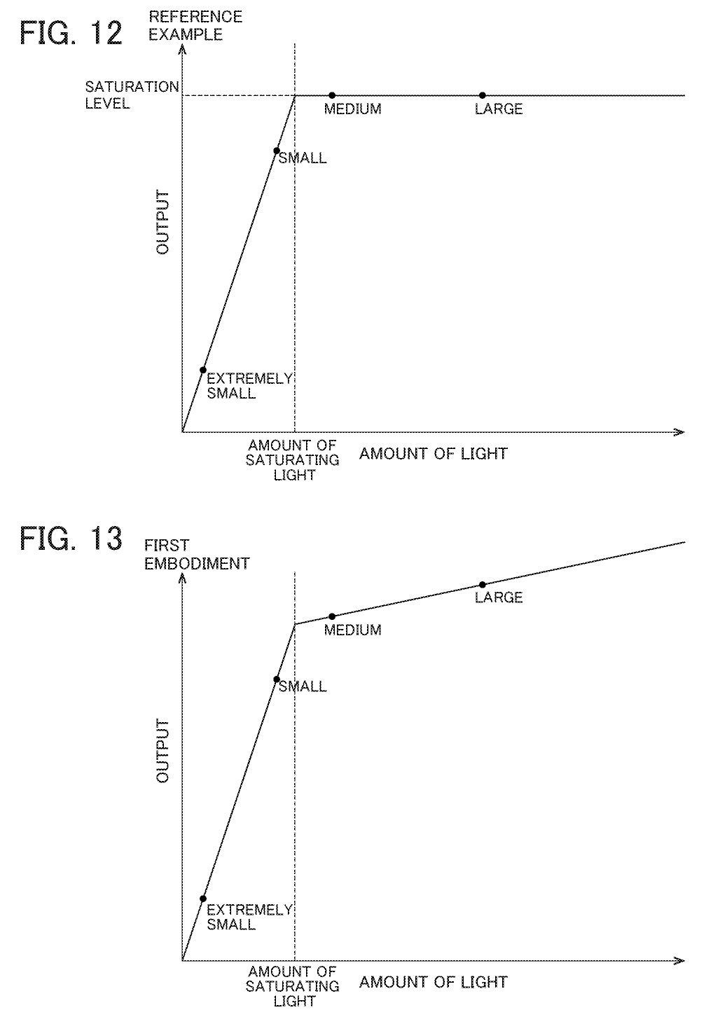

FIG. 12 is a graph showing a relationship between: an amount of light received with a pixel included in the imaging device of the reference example; and an output obtained from the pixel. FIG. 13 is a graph showing a relationship between: an amount of light received with a pixel 111 included in the imaging device 1 of the first embodiment; and an output obtained from the pixel 111.

In the graphs of FIGS. 12 and 13, the horizontal axis represents amount of light and the vertical axis represents output. The graphs of FIGS. 12 and 13 show a relationship between the amount of light and the output when the amount of light received with the pixel is extremely small, small, medium, and large.

As to the imaging device of the reference example, when the light-exposure time period reaches the time period T and the output is read out, the output is different between when the amount of light is extremely small and when the amount of light is small; whereas, the output is the same between when the amount of light is medium and when the amount of light is large. Hence, when the amount of light is medium and large, images of a white object and, for example, a light-reflective object have a whiteout, and brightness of the images cannot be determined. More typically, as to the imaging device of the reference example, as shown in FIG. 12, the output is greater as the amount of light is larger if the amount of light is smaller than, or equal to, an amount of saturating light. Whereas, if the amount of light is larger than the amount of saturating light, the output remains at a saturation level even if the amount of light is larger.

As to the imaging device 1 of the first embodiment, when the light-exposure time period reaches the time period T and the output is read out, the output is different between when the amount of light is extremely small and when the amount of light is small. Furthermore, the output is different between when the amount of light is medium and when the amount of light is large. Hence, when the amount of light is medium and large, images of a white object and, for example, a light-reflective object do not have a whiteout, and brightness of the images can be determined. Thus, as to the imaging device 1 of the first embodiment, correction is performed on the output in accordance with an HDR rate. Hence, as shown in FIG. 13, the output is greater as the amount of light is larger in both of the cases where the amount of light is smaller than, or equal to, the amount of saturating light and where the amount of light is larger than the amount of saturating light. That is, the HDR can be achieved.

The imaging device 1 of the first embodiment divides the light-exposure time period into the first light-exposure time period T1 that is relatively long and the second light-exposure time period T2 that is relatively short. Thus, a shingle-shot HDR is achieved. The relatively long first light-exposure time period T1 is useful for determining brightness of an image of a black object. The relatively short second light-exposure time period T2 is useful for determining brightness of an image of, for example, a light-reflective object. The first light-exposure time period T1 and the second light-exposure time period T2 can be set in any given length.

In order to achieve the single-shot HDR, a frame memory structure is required to transfer electric charges at the same timing from the photoelectric conversion units 171 included in the p × q pixels 111 and store the transferred electric charges until the transferred electric charges are read out. Hence, one photoelectric conversion unit 171 is provided with two electric-charge holding units including the first electric-charge holding unit 172 and the second electric-charge holding unit 173.

### 1.11 Calculation of Digital Values

As to the imaging device 1 of the first embodiment, whether the pixel circuit 161 is saturated is determined prior to analog-to-digital conversion to be performed on a decrease in the signal voltage VSIG of the analog pixel signal 132. If the pixel circuit 161 is not saturated, the analog-to-digital conversion is performed on the first decrease Δ1 in the signal voltage VSIG of the analog pixel signal 132 in accordance with the amount of the first electric charges Q1 and the second electric charges Q2. If the pixel circuit 161 is saturated, the analog-to-digital conversion is performed on the second decrease Δ2 in the signal voltage VSIG of the analog pixel signal 132 in accordance with the amount of the second electric charges Q2. Hence, either the first decrease Δ1 or the second decrease Δ2 alone is subjected to the analog-to-digital conversion.

The counter 197 basically indicates: the first decrease Δ1 with a value in a lower half of a range of values that a digital value can take; and the second decrease Δ2 with a value in an upper half of a range of values that a digital value can take. For example, if the digital value has a 10-bit wide and can take a value within a range of 1024 LSB, the counter 197 indicates: the first decrease Δ1 with a value within a range of lower 512 LSB; and the second decrease Δ2 with a value within a range of upper 512 LSB. Hence, if the first decrease Δ1 and the second decrease Δ2 are indicated with values within substantially the same range, the first decrease Δ1 and the second decrease Δ2 can be converted from analog to digital in substantially the same precision even if the first decrease Δ1 and the second decrease Δ2 are converted from analog to digital with the same analog-to-digital converting circuit 165.

The counter 197 calculates a digital value not to alter a relationship between an amount of light and a digital value even if either the first decrease Δ1 or the second decrease Δ2 is subjected to analog-to-digital conversion. Such a feature makes it possible to calculate an appropriate digital value even in a case where the first decrease Δ1 has to be indicated inevitably with a digital value within an upper half range because of, for example, fluctuations in characteristics of elements included in the imaging device 1 even though the first decrease Δ1 has undergone analog-to-digital conversion, or a case where the second decrease Δ2 has to be indicated inevitably with a digital value within a lower half range because of, for example, fluctuations in characteristics of elements included in the imaging device 1 even though the second decrease Δ2 has undergone analog-to-digital conversion.

With the above matters considered, the analog-to-digital converting circuit 165 performs processing below. As to the processing below, a sum of the first light-exposure time period T1 and the second light-exposure time period T2 is n times the second light-exposure time period T2. Furthermore, when the first decrease Δ1 is converted from analog to digital, a count value at which the pixel circuit 161 is saturated is a first saturation count value. When the second decrease Δ2 is converted from analog to digital, a count value at which the pixel circuit 161 is saturated is a second saturation count value.

The counter 197 obtains a count value based on a decrease in the signal voltage VSIG, and calculates a digital value from the obtained count value. The obtained count value indicates the number of counted clocks. Basically, the count value to be obtained when the first decrease Δ1 is subjected to analog-to-digital conversion is a count value within a range between a minimum count value and the first saturation count value. The count value to be calculated when the second decrease Δ2 is subjected to analog-to-digital conversion is a count value within a range between the second saturation count value and a maximum count value. The second light-exposure time period T2 is 1/n times a sum of the first light-exposure time period T1 and the second light-exposure time period T2. Hence, the second saturation count value is 1/n times the first saturation count value. However, for example, because of fluctuations in characteristics of elements included in the imaging device 1, a count value obtained when the first decrease Δ1 is subjected to analog-to-digital conversion could be larger than the first saturation count value, and a count value obtained when the second decrease Δ2 is subjected to analog-to-digital conversion could be smaller than the second saturation count value.

The counter 197 matches a digital value calculated from the first saturation count value in the analog-to-digital conversion on the first decrease Δ1 with a digital value calculated from the second saturation count value in the analog-to-digital conversion on the second decrease Δ2.

Furthermore, the counter 197 sets a ratio of an increase in the digital value to an increase in the count value in the analog-to-digital conversion on the first decrease Δ1 to 1/n times a ratio of an increase in the digital value to an increase in the count value in the analog-to-digital conversion on the second decrease Δ2.

Thanks to such a feature, the relationship between an amount of light and a digital value is constant even if either the first decrease Δ1 or the second decrease Δ2 is subjected to analog-to-digital conversion. Furthermore, the digital value can be obtained in accordance with the amount of light regardless of whether the amount of light is either small or large. Such a feature can enhance resolution of the amount of light if the light amount is small.

Described below will a specific example of the above features in a case where n is 32 as an example.

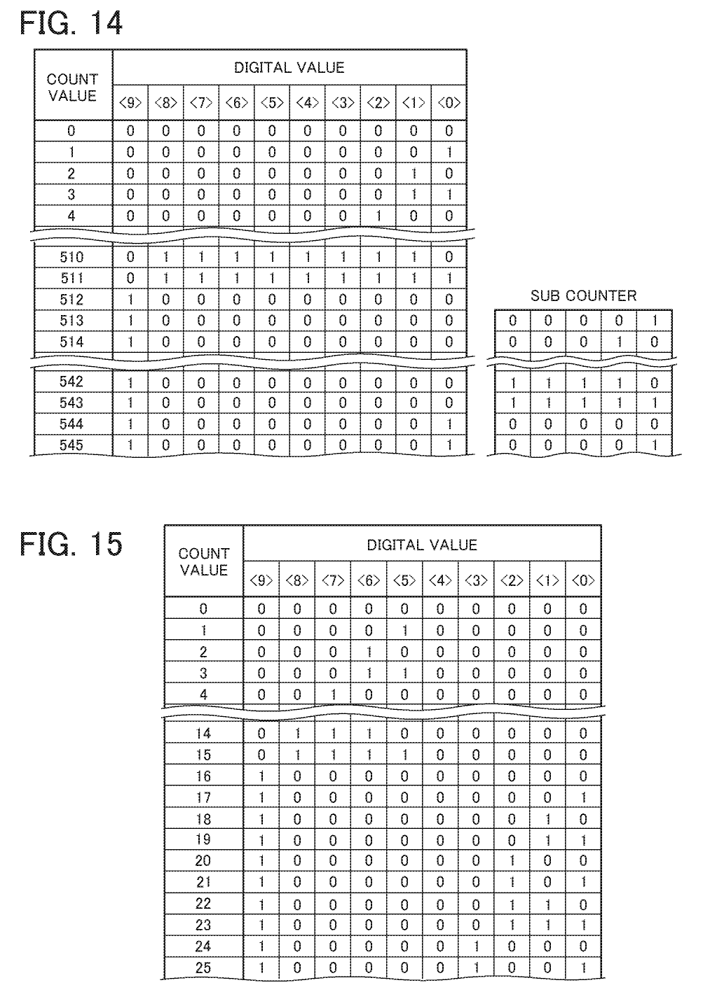

FIG. 14 is a table showing a relationship between: a count value obtained with the counter 197, which is included in the imaging device 1 of the first embodiment, when a pixel circuit 161 included in the imaging device 1 is not saturated; and a digital value calculated with the counter 197. FIG. 15 is a table showing a relationship between: a count value obtained with the counter 197, which is included in the imaging device 1 of the first embodiment, when a pixel circuit 161 included in the imaging device 1 is saturated; and a digital value calculated with the counter 197.

As shown in FIG. 14, in a case where the pixel circuit 161 is not saturated and the first decrease Δ1 is subjected to analog-to-digital conversion, if the count value is smaller than, or equal to, a first saturation count value of “512”, the digital value increments by “1 LSB” when the count value increments by “1”. However, if the count value is greater than a first saturation count value of “512”, a sub count value counted with a sub counter increments by “1 LSB” when the count value increments by “1”, and the digital value increments by “1 LSB” when the sub count value increments by “32 LSB”. Hence, when the count value increments by “32 LSB”, the digital value increments by “1 LSB”.

As shown in FIG. 15, in a case where the pixel circuit 161 is saturated and the second decrease Δ2 is subjected to analog-to-digital conversion, if the count value is smaller than, or equal to, a second saturation count value of “16”, the digital value increments by “32 LSB” when the count value increments by “1”. However, if the count value is greater than a second saturation count value of “16”, the digital value increments by “1 LSB” when the count value increments by “1”.

The increment “32 LSB” in the digital value when the count value increments by “1” in a range where the second saturation count value is “16” or smaller as seen in FIG. 15 is 32 times the increment “1 LSB” in the digital value when the count value increments by “1” in a range where the first saturation count value is “512” or smaller as seen in FIG. 14. The increment “32LSB” in the digital value when the count value increments by “32” in a range where the second saturation count value is larger than “16” as seen in FIG. 15 is 32 times the increment “1 LSB” in the digital value when the count value increments by “32” in a range where the first saturation count value is larger than“512” as seen in FIG. 14. A digital value “1000000000b” calculated from the second saturation count value “16” seen in FIG. 15 is the same as a digital value “1000000000b” calculated from the first saturation count value “512” seen in FIG. 14.

The present disclosure shall not be limited to the above-described embodiments, and may be replaced with a configuration substantially the same as a configuration having the same advantageous effects as, or a configuration capable of achieving the same object as, the configurations described in the above embodiments.

What is claimed is:

1. An imaging device, comprising:
a pixel circuit including a photoelectric conversion unit, a first electric-charge holding unit, a second electric-charge holding unit, a floating diffusion, a transfer circuit configured to transfer electric charges from the photoelectric conversion unit to the floating diffusion either through the first electric-charge holding unit or through the second electric-charge holding unit, and an output circuit configured to output an analog pixel signal having a signal voltage based on an amount of the electric charges transferred to the floating diffusion;
an analog-to-digital converting circuit configured to perform analog-to-digital conversion on a decrease in the signal voltage; and
a control unit,
wherein the control unit:
causes the transfer circuit to transfer first electric charges, generated by the photoelectric conversion unit in a first light-exposure time period, from the photoelectric conversion unit to the first electric-charge holding unit, to transfer second electric charges, generated by the photoelectric conversion unit in a second light-exposure time period shorter than the first light-exposure time period, from the photoelectric conversion unit to the second electric-charge holding unit, and to transfer the first electric charges from the first electric-charge holding unit to the floating diffusion and then to transfer the second electric charges from the second electric-charge holding unit to the floating diffusion; and
causes the analog-to-digital converting circuit to perform analog-to-digital conversion on a decrease selected from a first decrease in the signal voltage observed when the first electric charges and the second electric charges are transferred to the floating diffusion and a second decrease in the signal voltage observed when the second electric charges are transferred to the floating diffusion.

2. The imaging device according to claim 1, further comprising
a determination circuit configured to determine whether a third decrease in the signal voltage, observed when the first electric charges are transferred to the floating diffusion, is greater than, or equal to, a reference,
wherein the control unit causes the analog-to-digital converting circuit to perform analog-to-digital conversion on the first decrease if the determination circuit determines that the third decrease is not greater than, or equal to, the reference, and causes the analog-to-digital converting circuit to perform analog-to-digital conversion on the second decrease if the determination circuit determines that the third decrease is greater than, or equal to, the reference.

3. The imaging device according to claim 2, further comprising:
a ramp voltage generating circuit configured to generate a ramp voltage raised from an initial voltage to a highest voltage, maintained at the highest voltage, and decreased from the highest voltage to a lowest voltage; and a saturation determination voltage generating circuit configured to generate a saturation determination voltage with reference to the lowest voltage,
wherein the determination circuit determines whether the third decrease is greater than, or equal to, the reference, using the saturation determination voltage.

4. The imaging device according to claim 2, further comprising
a ramp voltage generating circuit configured to generate a ramp voltage,
wherein the decrease is a decrease after the analog-to-digital converting circuit is initialized,
the analog-to-digital converting circuit includes a comparator configured to compare the decrease with the ramp voltage, and
after the analog-to-digital converting circuit is initialized, the determination circuit determines whether the third decrease is greater than, or equal to, the reference, using the comparator.

5. The imaging device according to claim 2,
wherein the decrease is a decrease after the analog-to-digital converting circuit is initialized,
the analog-to-digital conversion performed by the analog-to-digital converting circuit on the first decrease includes initializing the analog-to-digital converting circuit before causing the transfer circuit to transfer the first electric charges from the first electric-charge holding unit to the floating diffusion, and
the analog-to-digital conversion performed by the analog-to-digital converting circuit on the second decrease includes initializing the analog-to-digital converting circuit before causing the transfer circuit to transfer the first electric charges from the first electric-charge holding unit to the floating diffusion and initializing the analog-to-digital converting circuit again after causing the transfer circuit to transfer the first electric charges from the first electric-charge holding unit to the floating diffusion and before causing the transfer circuit to transfer the second electric charges from the second electric-charge holding unit to the floating diffusion.

6. The imaging device according to claim 1, further comprising:
an effective pixel; a first optical black pixel; and a second optical black pixel,
wherein each of the effective pixel, the first optical black pixel, and the second optical black pixel includes the pixel circuit,
the imaging device further comprises an analog-to-digital converting circuit for the effective pixel, an analog-to-digital converting circuit for the first optical black pixel, and an analog-to-digital converting circuit for the second optical black pixel, each of the analog-to-digital converting circuits being configured to convert a decrease in a signal voltage of an analog pixel signal into a digital pixel signal, and the analog pixel signal being output from the effective pixel, the first optical black pixel, and the second optical black pixel, and
the control unit causes the analog-to-digital converting circuit for the first optical black pixel to perform analog-to-digital conversion on the first decrease and the analog-to-digital converting circuit for the second optical black pixel to perform analog-to-digital conversion on the second decrease.

7. The imaging device according to claim 6, further comprising:
a correction circuit configured to: correct a digital pixel signal to be obtained from the effective pixel using a digital pixel signal to be obtained from the first optical black pixel, if the analog-to-digital converting circuit for the effective pixel involves analog-to-digital conversion on the first decrease; and correct a digital pixel signal to be obtained from the effective pixel using a digital pixel signal to be obtained from the second optical black pixel, if the analog-to-digital converting circuit for the effective pixel involves analog-to-digital conversion on the second decrease.

8. The imaging device according to claim 1,
wherein a sum of the first light-exposure time period and the second light-exposure time period is n times the second light-exposure time period, and
the analog-to-digital converting circuit:
obtains a count value based on the decrease and calculates a digital value from the count value;
match a digital value calculated from a first saturation count value in the analog-to-digital conversion on the first decrease with a digital value calculated from a second saturation count in the analog-to-digital conversion on the second decrease, the second saturation count value being 1/n times the first saturation count value; and
sets a ratio of an increase in the digital value to an increase in the count value in the analog-to-digital conversion on the first decrease to 1/n times a ratio of an increase in the digital value to an increase in the count value in the analog-to-digital conversion on the second decrease.
